(19) United States
(12) Patent Application Publication
(10) Pub. No.: US 2004/0054652 A1
(43) Pub. Date: Mar. 18, 2004

(54) Data filtering for adapting data delivery to diverse client devices

(76) Inventors: Jin Teik Teh, Los Altos, CA (US); Ling Wang, Union City, CA (US)

Correspondence Address: Jason Z. LIN, Supreme Patent Services, Post Office Box 2339, Saratoga, CA, 95070-0339, US

(21) Appl. No.: 10/618,036

(22) Filed: Jul. 11, 2003

Related U.S. Application Data
(60) Provisional application No. 60/410,583, filed on Sep. 12, 2002.

(51) Int. Cl. G06F 7/00

(52) U.S. Cl. 707/1

(57) ABSTRACT

The present invention, data filtering for adapting data delivery to diverse client devices, comprises a data transforming process and a data filtering process. The data transforming process transforms the original content data into multiple versions of content data and stores into the content cache for the diverse client devices, by using the device character of the all client devices. On the other hand, the data filtering process, on requesting of a certain client device, first finds out a best version of content data from the content cache, and then transmits it to the requesting client device.

### FIELD OF THE INVENTION

This invention relates to a data filtering technique and, more particularly, to a method for adapting data delivery from server to client devices with varied character and limitations.

### BACKGROUND OF THE INVENTION

A virtual hosting, general purpose data delivery platform is to deliver applications and content to customers, and the content data usually may includes image data, video data, audio data, text data, records, forms, applications, and so on. Refer to FIG. 1, a configuration diagram of the client-server environment is shown, the platform server 100 is the server platform that resides within the infrastructure network. The application server, which is a third-party server and may reside either outside or inside the customer's local area network, is a server that handles all processes and tasks specific to an application, a product or a service. There are basically two classes of application servers: content application server 102 and service application server 101. The content application server 102 is an application server that specializes in sending non-personal content, such as stock quotes, while the service application server 101 is an application server that provides personalized services, such as stock trading.

The client device 110 connected in the data delivery network is to be resided by both platform client 111 and application client 112. The platform client 111 is a thin-client that provides generic functionality to transfer messages between the application servers 101, 102 and the application clients 112. The platform client 111 provides a controller and a shell for application clients 112 to provide services, specialized processes or content to users. The platform client 111 routes data and commands between application clients 112, and between the application servers 101, 102 and the application clients. 112. As for the application client 112, it is usually a separate module or process that provides a specific task for the client. For example, it can be a module handles drawing of vector graphics, the playing of MP3 audio files or other functions.

Due to the rapid growth of the applications in the client-server environment, the client devices with varied character and limitations are connected to the network. Some examples of client devices are personal computer, personal digital assistant (PDA) and cellular phone. These client devices usually have drastically different character in terms of screen size, resolution, color depth, and so on. Therefore, it is important for a data delivery system to have an efficient method to deliver data to client devices with varied character and limitations.

### SUMMARY OF THE INVENTION

The present invention, data filtering for adapting data delivery to diverse client devices, allows a set of content data to be sent with minimal processing to devices of different character quickly and efficiently.

In order to reach the aforementioned purpose, this invention requires that the source content data consists of multiple versions of the original content data. For example, if a content data is an image file, the source image must consist of multiple version of the original image, and each version may be of a different size or resolution of the original image.

Before a content data is sent to a client device, the entire set of that content data, together with the ID of the client device which the content data will be sent to, is sent to the data filtering processor. The data filtering processor uses the client device ID to look up the device's capability information. Based on the device capability information, the data filtering processor can select the best version of the content data to the client device.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

FIG. 1 is a configuration diagram of the client-server environment;

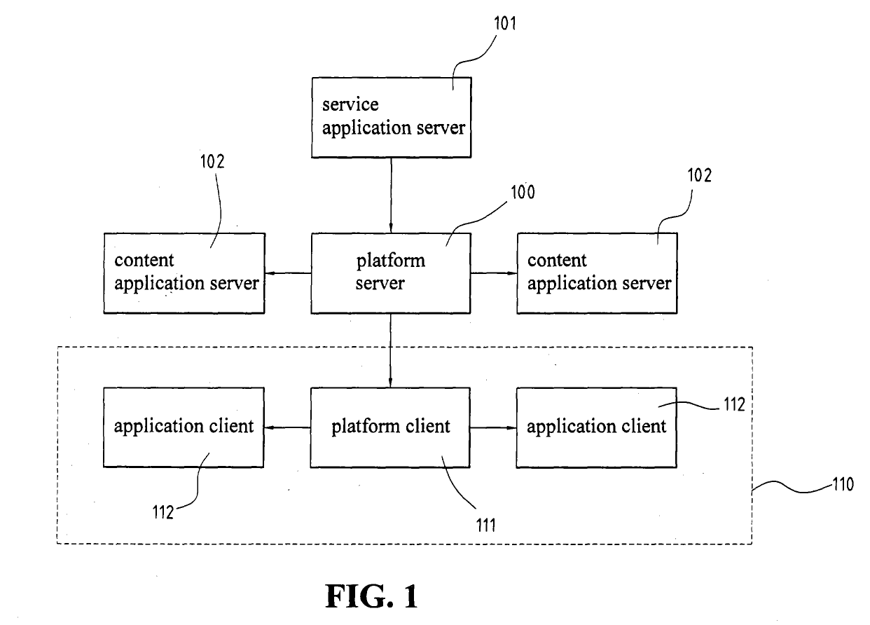

FIG. 2 is a preferred embodiment of field definition of the device capability table (DCT) of the present invention;

FIG. 3 is a preferred embodiment of the flowchart of a data transforming method of the present invention; and

FIG. 4 is a preferred embodiment of the flowchart of a data filtering method of the present invention.

### DETAILED DESCRIPTION OF THE INVENTION

There is a content cache in the platform server which the data transforming processor and data filtering processor can use for storing data. The content cache is a short-term storage used for storing common or public data that can be delivered to one or more users. The content is retrievable by certain criteria such as category or selection criteria.

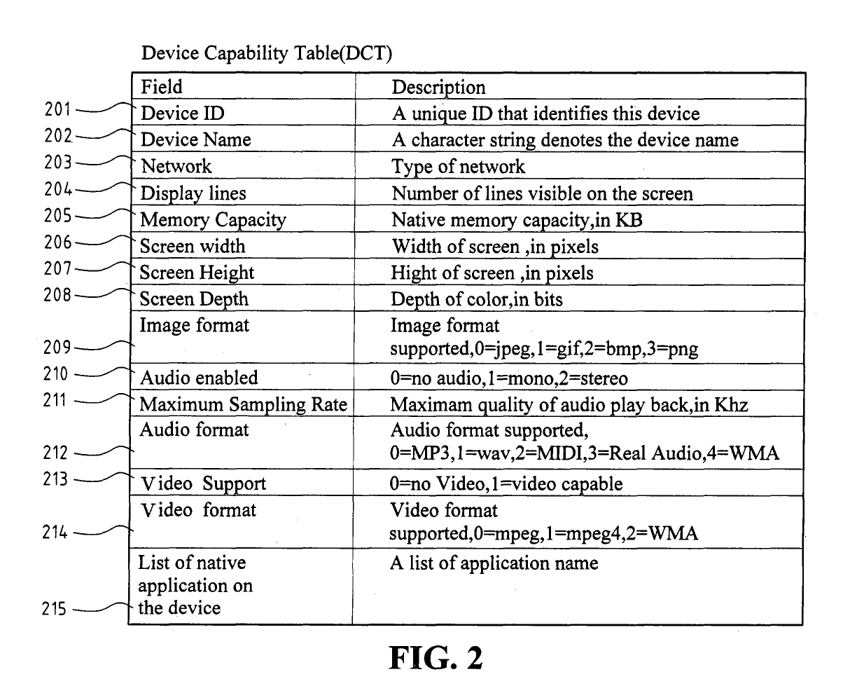

The device capability table (DCT) describes the physical character of a device. As shown in FIG. 2, there is one entry in the DCT for each device that the platform server supports. For example, there is one record each for Nokia 3390, 3395, 6110, etc.

Note that the Device ID 201 is a globally unique id that identifies each type of device that the platform server currently or in the future will support. A different id is used to differentiate different types of similar devices, e.g. between a Compaq iPAQ H3135 and a Compaq iPAQ H3635. In addition, the Device name 202 is a character string that gives a description of this device, e.g. “Nokia 9210”. Refer to FIG. 2, a record in the DCT consists of 15 fields to define the character of a client device. The fields of “Screen width 206”, “Screen height 207”, “Screen depth 208”, and “Image format 209” are specially related to the image data. Similarly, the fields specially related to audio data or ivdeo data could be easily found out.

A device information management module has the task for maintaining the device capability table. The typical functions of the management module include: adding new devices to, modifying existing devices in, and deleting existing old devices from the device capability table; that is, when the client devices connected to the network are changed, the device capability table (DCT) must be updated.

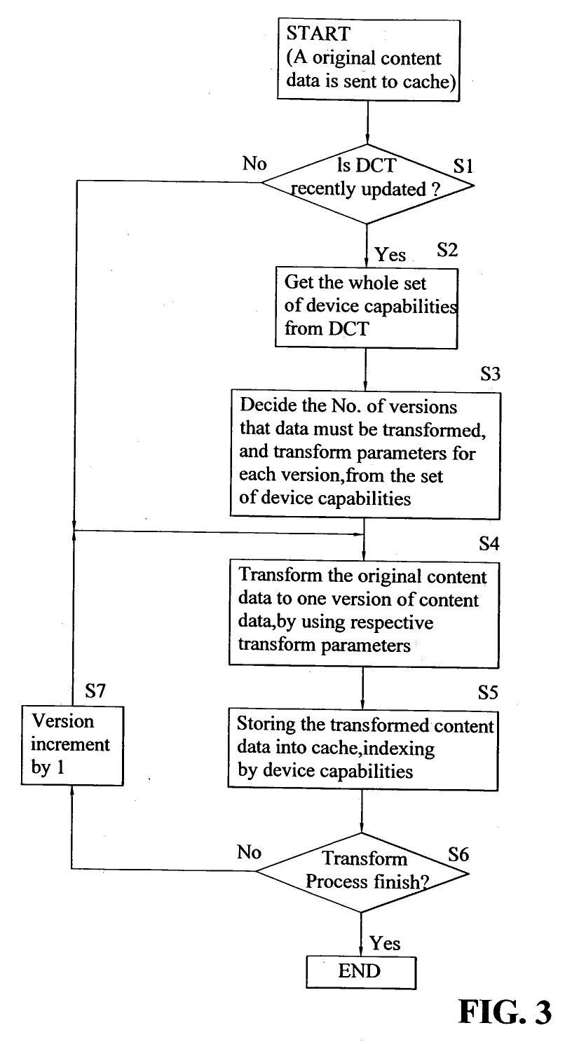

FIG. 3 shows the flowchart of the data transforming process. As shown in FIG. 3, this process is initiated when an original content data is sent to the content cache. In step S1, it tests whether the DCT is recently updated. If it is not, then go to step S4 for executing data transformation. If it is, the number of versions of transforming data must be decided again. In step S2, it is to get the whole set of device character from DCT. In step S3, it is to decide the number of versions that content data must be transformed first, and then calculate the transform parameters for each version of transformed data, both from the set of device character. In step S4, it is to transform the original content data to a version of content data, by using the respective transform parameters. Note that the data transforming process includes resolution conversion, and format transformation if necessary. In step S5, it is to store the version of transformed content data into content cache, indexed by the device character. In step S6, it is to test whether the transforming process is finished. If no, increment the version number by 1 in step S7, and then return to step S4 for another version of data transforming.

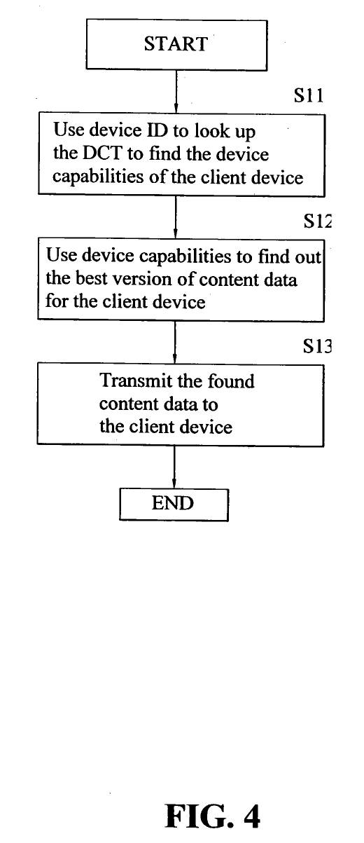

Next, when a client device requests a content data from the server, the data filtering process as shown in FIG. 4 is activated. In step S11, it is to use the device ID of the requesting client device to look up the DCT to find the device character of the requesting client device. In step S12, to use the device character to find out the best version of content data from content cache which is most suitable for the requesting client device. And, finally in step S13, to transmit the best version of content data to the requesting client device.

While the invention has been described in connection with what is presently considered to the most practical and preferred embodiment, it is to be understood that the invention is not to be limited to the disclosed embodiment, but on the contrary, is intended to cover various modifications and equivalent arrangement included within the spirit and scope of the appended claims.

What is claimed is:

1. A data transformation method, the method comprising:
identifying a device character of a client device, then obtaining an identified result;
calculating a transformation parameter according to the identified result; and
transforming an original content data into a transformed content data according to the transformation parameter.

2. A data transforming method of claim 1, wherein after transforming the original content data, further comprising:
storing the transformed content data into a content cache, indexed by a set of device character.

3. A data transforming method of claim 1, wherein the content data is an image data, and the device character is image related parts.

4. A data transforming method of claim 1, wherein the content data is a video data, and the device character is video related parts.

5. A data transforming method of claim 1, wherein the content data is an audio data, and the device character are audio related parts.

6. A data transforming method of claim 1, wherein the device character of the all client device being stored in a device capability table (DCT).

7. In a server having a device capability table (DCT) storing the device character of the all client devices, a data filtering method able to find out the best version of the content data stored in a content cache and transmit it to the requesting client device, the method comprising the steps of:
obtaining the device character of the requesting client device from the DCT;
using the obtained device character to find out the best version of the content data from the content cache; and
transmitting the best version of the content data to the requesting client device.

8. A data filtering method of claim 6, wherein the content data being an image data, and the device character being image related parts.

9. A data filtering method of claim 6, wherein the content data being a video data, and the device character being video related parts.

10. A data filtering method of claim 6, wherein the content data being an audio data, and the device character being audio related parts.

11. A platform server with a content cache and a device capability table (DCT), the server comprising:
a memory;
a first set of program instructions for transforming a original content data into a t transformed content data; and
a second set of program instructions, which for responding when a request which is sent from a certain client device.

12. A platform server of claim 11, wherein the first set of program instructions further comprising:
a identifying module, for identifying a device character of a client device and storing the device character in the DCT;
a calculating module, for calculating a transformation parameter according to the device character in the DCT; and
a transforming module, for transforming an original content data into a transformed content data according to the transformation parameter; and
a storing module, for storing the transformed content data into a content cache, indexed by a set of device character.

13. A platform server of claim 11, wherein the second set of program instructions further comprising:
a obtaining module, for obtaining a device character from the DCT, wherein the device character is owned a client device which sends a request;
a determining module, for determining a version of content data suitable for the client device according to the device character; and
a transmitting module, for transmitting the determined version of the content data to the client device.

14. A platform server of claim 11, wherein said the content data being an image data and the device character being image related parts.

15. A platform server of claim 11, wherein the content data being a video data, and the device character being video related parts.

16. A platform server of claim 11, wherein the content data being an audio data, and the device character being audio related parts.

17. A platform server of claim 11, wherein the memory is a hard disk.
